(19) United States
(12) Patent Application Publication
(10) Pub. No.: US 2015/0149234 A1
(43) Pub. Date: May 28, 2015

(54) SYSTEMS AND METHODS FOR AIRLINE FLEET RETIREMENT PREDICTION

(71) Applicant: General Electric Company, Schencectady, NY (US)

(72) Inventors: Adam Rasheed, Niskayuna, NY (US); John Andrew Ellis, Niskayuna, NY (US); Venkatraman Ananthakrishnan Iyer, Wilton, CT (US); Keith Robert Lesch, Liberty Township, OH (US)

(73) Assignee: General Electric Company, Schenectady, NY (US)

(21) Appl. No.: 14/092,519

(22) Filed: Nov. 27, 2013

(51) Int. Cl. G06Q 10/06

(52) U.S. Cl. CPC G06Q 10/06315
USPC 705/7.25

(57) ABSTRACT

Systems and methods for airline fleet retirement prediction are provided. One methods includes obtaining market information for the airline that defines at least one market for the airline, determining a plurality of aircraft types (priority groupings) for the airline within the at least one market to define an airline fleet model, and determining deployment priorities for the plurality of aircraft types within the at least market. The method further includes developing one or more operational models using at least one of airline operational data or airline fleet data for the plurality of aircraft types and determining aircraft retirement prediction data for the airline using the airline fleet model and the one or more operational models developed for the airline.

### BACKGROUND

Forecasting is used in many different applications or industries to facilitate planning. For example, in some industries, it is beneficial to forecast the retirement level of equipment for various requirements. In the airline industry, the forecasting may include forecasting the retirement level for use in fleet planning, maintenance planning, spare parts requirements, etc. It is often difficult in the airline industry to predict how many aircraft will be needed and for how long. Additionally, the type of information provided or analyzed, while helpful for some forecasting, may not provide useful information for other types of forecasting.

Conventional approaches to forecasting, particularly in the airline industry, typically perform analysis at a global level. While this forecasting may facilitate planning for some applications, because this forecasting only considers, for example, high-level global economics, the forecasting may not be applicable to some sectors or desired non-global forecasting in the airline industry. Thus, conventional forecasting methods may not provide beneficial information for some retirement level planning in the airline industry. For example, the forecast retirement of one or more aircraft across the entire airline industry may not facilitate accurate forecasting with respect to particular sectors or specific airlines within the aircraft industry. Accordingly, conventional forecasting methods may not perform satisfactorily for all applications of, for example, fleet planning and capital allocation costs.

Thus, conventional approaches or attempts to analytically predict aircraft retirement determine a global aircraft retirement profile across all airlines. The global prediction is useful for some entities or sectors, such as manufacturers of aircraft that are concerned with the overall sale of aircraft units. However, for other entities or sectors, a global prediction model does not provide information to facilitate, for example, accurate fleet planning or maintenance planning for a specific airline.

### BRIEF DESCRIPTION

In one embodiment, a non-transitory computer readable storage medium for predicting aircraft retirement within a fleet of an airline using a processor is provided. The non-transitory computer readable storage medium includes instructions to command the processor to obtain market information for the airline that defines at least one market for the airline, determine a plurality of priority aircraft types (priority groupings) for the airline within the at least one market to define an airline fleet model, and determine deployment priorities for the plurality of aircraft types within the at least market. The non-transitory computer readable storage medium includes instructions to further command the processor to develop one or more operational models using at least one of airline operational data or airline fleet data for the plurality of aircraft types and determine aircraft retirement prediction data for the airline using the airline fleet model and the one or more operational models developed for the airline.

In another embodiment, a computer-implemented system for predicting retirement of aircraft from an airline fleet is provided. The system includes a logic subsystem that controls an airline fleet retirement modeling framework to perform one or more methods described herein.

### BRIEF DESCRIPTION OF THE DRAWINGS

FIG. 1 is a diagram illustrating an airline fleet model in accordance with various embodiments.

FIG. 2 is a block diagram of a system for predicting the retirement of aircraft from an airline fleet in accordance with an embodiment.

FIG. 3 is a flowchart of a method for predicting the retirement of aircraft from an airline fleet in accordance with an embodiment.

FIG. 4 is a diagram of an example of an airline fleet model with aircraft types.

FIG. 5-8 are graphs showing examples of historical airline data corresponding to the aircraft types of FIG. 4 for the airline.

FIG. 9 are tables showing examples of forecast delivery schedules corresponding to the aircraft types of FIG. 4 for the airline.

FIG. 10 is a graph of an example of output curves for forecast of aircraft retirements for the aircraft types of FIG. 4 for the airline.

### DETAILED DESCRIPTION

Various embodiments will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors, controllers, or memories) may be implemented in a single piece of hardware (e.g., a general purpose signal processor or random access memory, hard disk, or the like) or multiple pieces of hardware. Similarly, any programs may be stand-alone programs, may be incorporated as subroutines in an operating system, may be functions in an installed software package, and the like. It should be understood that the various embodiments are not limited to the arrangements and instrumentality shown in the drawings.

As used herein, the terms “system,” “unit,” or “module” may include a hardware and/or software system that operates to perform one or more functions. For example, a module, unit, or system may include a computer processor, controller, or other logic-based device that performs operations based on instructions stored on a tangible and non-transitory computer readable storage medium, such as a computer memory. Alternatively, a module, unit, or system may include a hard-wired device that performs operations based on hard-wired logic of the device. The modules or units shown in the attached figures may represent the hardware that operates based on software or hardwired instructions, the software that directs hardware to perform the operations, or a combination thereof.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Various embodiments provide systems and methods for predicting or forecasting aircraft retirement within an airline fleet that models an entire airline considering individual aircraft utilization. For example, various embodiments provide methods and algorithms to allocate an airline fleet into prioritized markets and use either historical-based or simulation-based models to predict the retirement of different aircraft models from the fleet. It should be noted that although the various embodiments are described in connection with the aviation industry, the embodiments described herein may be implemented in different applications and within different industries, such as in the rail and trucking industries, among others. For example, various embodiments may be applied to any “fleet” of equipment that undergoes reallocation and replacement, such as IT computers. For example, the general framework of various embodiments can be applied to any “equipment fleet” where there is a preferred order of use, redeployment and retirement.

At least one technical effect of various embodiments is improved or more accurate prediction of the retirement of aircraft from an airline fleet. At least one technical effect of various embodiments is improved understanding of different fleet retirement scenarios for airline customers that allows an improved understanding of the impact of different what-if scenarios (e.g., what if the economy grows at 2%, 5%, etc.). At least one technical effect of various embodiments is long term predictability of the retirement of aircraft from an airline fleet.

More particularly, various embodiments provide one or more prediction or forecast methods that allocate different aircraft into “markets” which, in some embodiments, include aircraft that fly similar routes and are used interchangeably by the airline. Additionally, the preferred order of use of the aircraft within each market (typically, most efficient at top, least efficient at bottom) are prioritized. Various embodiments may also include consideration of different factors, such as redeployment of aircraft across markets. Accordingly, in some embodiments, demand forecast is input to a model and allocated to each market. The demand is then allocated to each aircraft within the market per the preferred order of use with unused aircraft retired, and ultimately an entire aircraft model is retired out of the fleet.

It should be noted that for an aircraft type that is retired (on an individual basis), in various embodiments, the aircraft type first goes into a “storage queue” and remains in the queue for a defined number years (e.g., user can set the time period, such as two years to approximate an actual scenario). While in the storage queue, the aircraft is available to be brought back into service if the market grows and needs additional aircraft. In this way, various embodiments align, track, or mimic actual operation of an airline. Accordingly, for example, an airline may have ten aircraft in 2010, then retire two of the aircraft such that that airline has eight aircraft in 2011, and then the market rebounds (e.g., market conditions improve) such that the airline brings one aircraft back into service in 2012 (such that the airline now has nine aircraft, and thereby allowing one aircraft to retire).

Additionally, when reference is made to “retiring” an aircraft, in various embodiments this generally means that the airline removes the aircraft from the airline's fleet. In some embodiments, this retirement may mean or correspond to an airline returning a leased aircraft at the end of the lease (and the aircraft will be re-leased to another airline), or the airline might sell the aircraft to another airline which continues to fly the aircraft, or sell to a scrap-yard. Thus, in various embodiments, to retire an aircraft does not mean that the aircraft is taken completely out of the world's active flying fleet.

In various embodiments, the prediction or forecasting of the retirement of aircraft from an airline fleet is determined on an airline by airline basis that uses market and priority information. For example, as described in more detail herein, aircraft types within each of a plurality of markets are determined, such that particular airplanes are binned or grouped together. For example, the markets in various embodiments are defined by the particular flight leg for the aircraft, such as the number of hours flown by the aircraft for a particular airline fleet. Thus, in various embodiments, forecasting is provided at an airline-specific level and not at a global airline industry level. For example, various embodiments consider airline-specific factors or realities (e.g., individual airline growth plans). In accordance with various embodiments, an airline-specific or airline centric approach is provided for retirement forecasting, which may be used, for example, for fleet planning, maintenance planning, and/or spare parts forecasting, among others. For example, in various embodiments, an entire airline is modeled to obtain a forecast for each of a plurality of aircraft within the fleet of the airline.

It should be noted that although various embodiments provide airline-specific analysis, one or more embodiments may be utilized or applied to, for example, a higher-level, regional-level, or global level analysis. Thus, for example, while various embodiments generate forecast retirement for an airline, the methods and algorithms described herein may be used for analysis of more than one airline or for an overall region or area.

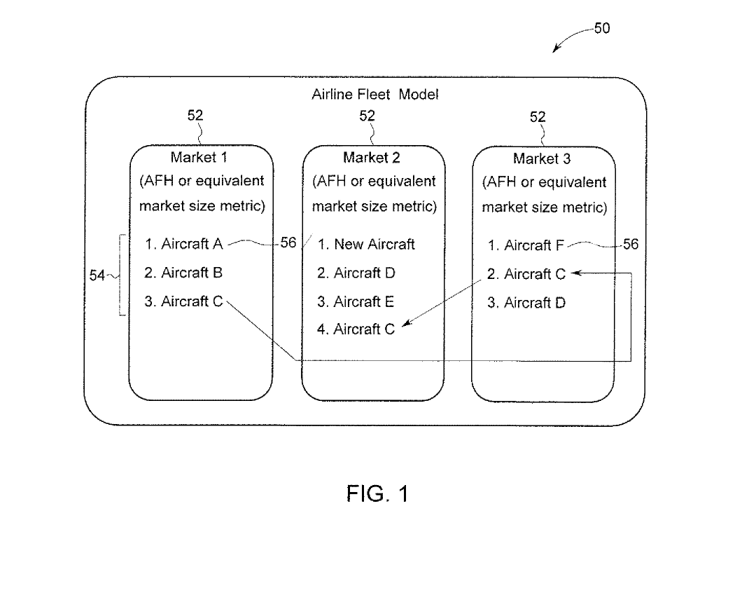

FIG. 1 illustrates an airline fleet model 50 in accordance with various embodiments. The airline fleet model 50 may be provided as a module or sub-subsystem in some embodiments, for example, implemented in hardware and/or software. The airline fleet model 50 defines a plurality of markets 52, illustrated as Market 1, Market 2 and Market 3 in this example. However, it should be appreciated that a greater or lesser number of markets may be defined, such as based on the interchangeability of the aircraft by a particular or specific airline. For example, one or more aircraft type (e.g., Airbus A330 or Boeing 747 aircraft type) are defined within each of the plurality of markets 52, such as based on flight leg usage for the aircraft. It should be noted that for different airlines, the defined markets 52 or aircraft types within each market 52 may be different as a result of, for example, how the airline uses different aircraft types. The market types may be defined, for example, based on flight leg ranges, such as transcontinental legs (e.g., greater than 2 hours within the U.S.), Atlantic legs (e.g., 8+ hours), Pacific legs (e.g., 10+ hours), and domestic (not long haul) legs (e.g., less than 2 hours within the U.S. or legs encompassing travel across about ⅓ of the U.S.). It should be noted that the definition of the markets 52 may be varied or changed as desired or needed, such as based on different flight times or leg distances.

Additionally, within each market 52, a priority order 54 is defined by prioritizing the usage of the aircraft by the airline within each of the markets 52. For example, within each market 52, the aircraft type 56 are ordered and prioritized based on a preferred usage for the aircraft type 56 by the airline. Thus, within each of the markets 52, a hierarchy or priority of aircraft types 56 is defined. Accordingly, in various embodiments, a plurality of priority groupings for the aircraft within an airline is determined. In various embodiments, the hierarchy or priority of aircraft types 56 is based on one or more factors or market size metrics as described in more detail herein. Accordingly, within each market 52, a higher prioritized aircraft type 56 is used before a lower prioritized aircraft type 56, which may be based on different factors and is airline specific or airline centric. As should be appreciated, the defined markets 52 and aircraft type 56 within each market 52, as well as the priority order 54 may be different, such as based on the usage pattern for the aircraft type 56 by a particular airline.

It should be noted that a particular aircraft type 56 may be redeployed within different markets 52 dynamically, for example, over time, as represented by the arrows in FIG. 1, illustrating market interactions showing a redeployment of the Aircraft C to different markets 52. Additionally, when an aircraft type 56 is moved from one market 52 to a different market 52, the priority of the aircraft type 56 may be different within that market 52 (as can be seen by the different priority order for Aircraft C moved from Market 1, to Market 3, and then to Market 2 in the illustrated embodiment). For example, an aircraft type 56 may be redeployed from one market 52 to another market 52 (represented by the arrows) if the aircraft type 56 is not needed in the market 52 (e.g., an initial market).

Thus, an airline fleet is represented by the markets 52 wherein each market 52 is defined by a grouping of aircraft that are used interchangeably by a specific airline. Because each airline may use aircraft differently, the grouping for one airline may be different than for another airline, even if the airlines have the same aircraft models in each corresponding fleet. Thus, various embodiments use information regarding how the specific airline being modeled uses different aircraft types 56. For example, one airline may be able to more efficiently use a particular aircraft type 56 for different defined flight legs than another airline.

It should be noted that in some embodiments, new aircraft types, such as new aircraft models that do not exist yet, but are in the design or manufacturing stage and have been ordered by the airline are typically listed as the highest priority groups because these new aircraft models will be the most fuel efficient/newest/least costly to operate. However, in some embodiments, a new aircraft type may also refer to a type of aircraft that is not new to the global industry, but is new to the particular airline and may be ordered because the aircraft type is better performing than existing aircraft type in the fleet of that airline.

As described herein, within each market 52, the aircraft type 56 is ordered in a preferred usage priority. Thus, with respect to the priority order 54, various embodiments use information that defines how the specific airline being modeled determines the priority usage of each of the aircraft types 56 within one or more of the markets 52 (e.g., reliability-based usage).

It should be noted that in various embodiments, a market size metric (MSM) as described in more detail herein is used to define the size of each market, determine the growth of the market and then subsequently how much capacity is allocated to each aircraft type within the market. For example, in some embodiments, a market size metric is defined as follows: aircraft flying hours (AFH) or capacity×AFH, where capacity may be, for example, the number of seats (for passenger) on the aircraft, or weight carrying capacity or volume carrying capacity, among others. In various embodiments, using historical data, the MSM facilitates determining the initial size of the market at the start of the forecasting process (e.g., simulation forecast). Additionally, the growth scenario (e.g., 2% per year or other defined or determined value) is then applied to the MSM to define how the market grows. Then, within a given year, the capacity is allocated to each aircraft within the market. Thus, each market 52 may have an MSM used to determine the size of the market 52.

With respect to the priority order 54, it should be appreciated that different metrics may be used to determine the priority within a market as desired or needed, which may be airline specific. As an example, different metrics for the priority order 54 may be used, such as different metrics based on the age or efficient usage of the particular aircraft type 56. For example, the defined order of usage for the priority order 54 may be determined based on fuel efficiency, where the more fuel efficient aircraft type 56 are higher in the priority order 54 than less fuel efficient aircraft type 56. As should be appreciated, in some embodiments, age may be used as a predictor of fuel efficiency, such that for an older aircraft type 56, a presumption exists that the aircraft type 56 is less fuel efficient than a newer aircraft type 56. As another example, the total “per hour operating cost” may be used as metric in some embodiments. However, in some embodiments, age and fuel efficiency are used as an approximation or estimation of the actual per hour operating cost. It should be noted that the total per hour operating cost may include one or more factors, for example, maintenance costs, crew costs, landing fees, fuel costs, etc.

Thus, aircraft usage for each aircraft type 56 is allocated within the market 52 in order of priority. For example, in the illustrated embodiment, in Market 1, Aircraft A might all be used, Aircraft B might all be used, and Aircraft C might only have 50% being used, with the remaining 50% retired out of the airline's fleet (or redeployed to another market 52 as shown going to Market 3 in the illustrated example). It should be noted that redeployment in various embodiments is considered at every time step in the simulation. However, in other embodiments, redeployment is considered or is determined to occur at defined interval blocks as you indicated above.

It should be noted that when an aircraft count (AC) reaches 0 for an aircraft type 56, the aircraft type 56 is considered retired from the fleet.

With respect to the information used in various embodiments, different inputs may be provided as discussed in more detail below. It should be noted that the inputs may be specific to, for example, a particular market 52, a particular aircraft type 56, or other information relevant to the airline fleet model 50 discussed herein. Again, as should be appreciated, the airline fleet model 50 is generated and analyzed for a particular airline. For example, as described herein, the airline fleet model 50 is developed and analyzed for a particular airline and the aircraft type 56 are prioritized for that airline based on information for that airline, such as aircraft usage information as described herein. Accordingly, instead of using information related to global aircraft demand across all airlines, various embodiments develop or generate an airline fleet model 50 that is airline specific or airline centric.

Additionally, with the aircraft type 56 that are included within a market 52, the market size for each of the markets 52 may be defined using one or more metrics. For example, the following equation may be used to define the market size metric: AFH×(number of seats on an airplane) for passenger aircraft; and AFH×(cargo carrying capacity) for cargo aircraft. The market size is then the sum of this equation for each of the aircraft within the market 52. It should be noted that variations are contemplated. For example, for the same aircraft type 56, depending on the market 52 in which the aircraft type 56 is being analyzed, different constraints may be used or a combination of constraints may be used. As one particular example, for a cargo based airline or aircraft type 56, for an inter-continental flight, a weight constrained approach may be used, such that the cargo carrying capacity is defined by the weight capacity of the cargo. However, for an intra-continental flight a volume constrained approach may be used, such that the cargo carrying capacity is defined by the volume capacity of the cargo. In other embodiments, a mixed or combined analysis may be performed based on a weight and volume constrained approach.

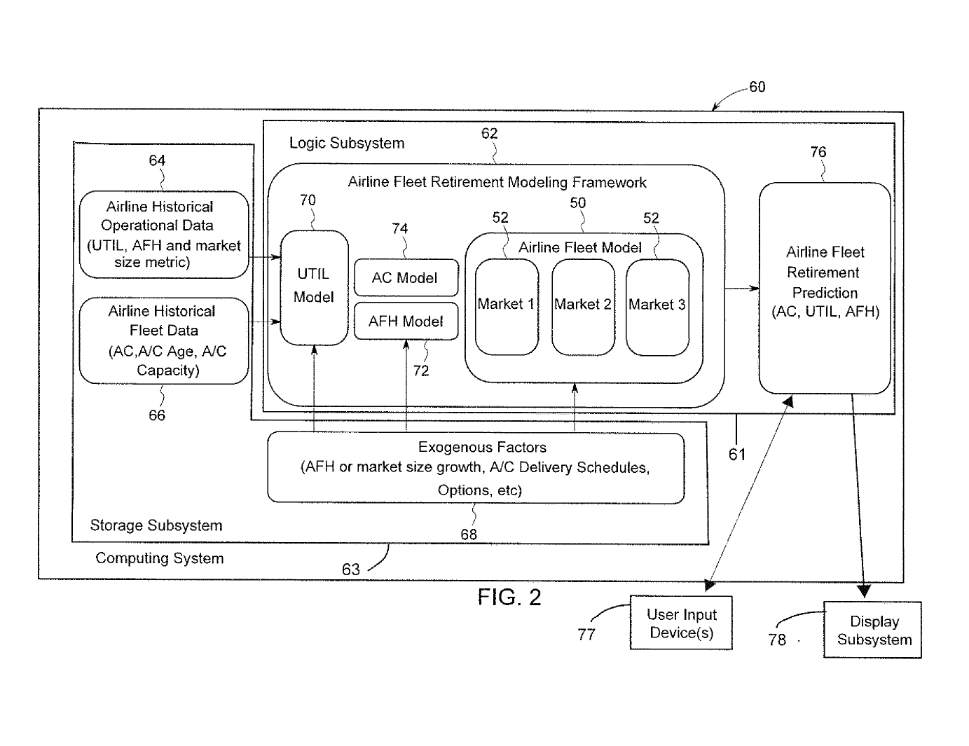

The airline fleet model 50 may be used, implemented, and/or performed, for example, as part of a system 60, which is a computing system as shown in FIG. 2 to predict the retirement of aircraft from an airline fleet for an airline. It should be noted that various embodiments may be implemented in connection with different computing systems. Thus, while a particular computing or operating environment may be described herein, the computing or operating environment is intended to illustrate operations or processes that be, implemented, performed, and/or applied to a variety of different computing or operating environments.

Thus, FIG. 2 schematically illustrates a non-limiting example of a computing system, configured in this embodiment as an airline fleet retirement forecasting computing system that may perform one or more methods or processes as described in more detail herein. The system 60 may be provided, for example, as any type of computing device, including, but not limited to, personal computing systems, military, among others.

In the illustrated embodiment, the computing system includes a logic subsystem 61, a storage subsystem 63 operatively coupled to the logic subsystem 61, one or more user input devices 77, and a display subsystem 78. The system 60 may optionally include components not shown in FIG. 2, and/or some components shown in FIG. 2 may be peripheral components that do not form part of or are not integrated into the computing system.

The logic subsystem 61 may include one or more physical devices configured to execute one or more instructions. For example, the logic subsystem 61 may be configured to execute one or more instructions that are part of one or more programs, routines, objects, components, data structures, or other logical constructs. Such instructions may be implemented to perform a task, implement a data type, transform the state of one or more devices, or otherwise arrive at a desired result. The logic subsystem 61 may include one or more processors and/or computing devices that are configured to execute software instructions. Additionally or alternatively, the logic subsystem 61 may include one or more hardware or firmware logic machines configured to execute hardware or firmware instructions. The logic subsystem 61 may optionally include individual components that are distributed throughout two or more devices, which may be remotely located in some embodiments.

The storage subsystem 63 may include one or more physical devices (that may include one or more memory areas) configured to store or hold data (e.g., airline operational data or airline fleet data) and/or instructions executable by the logic subsystem 63 to implement one or more processes or methods described herein. When such processes and/or methods are implemented, the state of the storage subsystem 63 may be transformed (e.g., to store different data or change the stored data). The storage subsystem 63 may include, for example, removable media and/or integrated/built-in devices. The storage subsystem 63 also may include, for example, other devices, such as optical memory devices, semiconductor memory devices (e.g., RAM, EEPROM, flash, etc.), and/or magnetic memory devices, among others. The storage subsystem 63 may include devices with one or more of the following operating characteristics: volatile, nonvolatile, dynamic, static, read/write, read-only, random access, sequential access, location addressable, file addressable, and content addressable. In some embodiments, the logic subsystem 61 and the storage subsystem 63 may be integrated into one or more common devices, such as an application specific integrated circuit or a system on a chip. Thus, the storage subsystem 63 may be provided in the form of computer-readable removable media in some embodiments, which may be used to store and/or transfer data and/or instructions executable to implement the various embodiments described herein, including the processes and methods.

In various embodiments, one or more user input devices 77 may be provided, such as a keyboard, mouse, or trackball, among others. However, it should be appreciated that that other user input devices 77, such as other external user input devices or peripheral devices as known in the art may be used. A user is able to interface or interact with the system 60 using the one or more input devices 77 (e.g., select or input data).

Additionally, in various embodiments, a display subsystem 78 (e.g., a monitor) may be provide to display information of data (e.g., one or more graphs) as described herein. For example, the display subsystem 78 may be used to present a visual representation of an output 76 (e.g., an airline fleet retirement prediction) or data stored by the storage subsystem 63. In operation, the processes and/or methods described herein change the data stored by the storage subsystem 63, and thus transform the state of the storage subsystem 63, the state of display subsystem 78 may likewise be transformed to visually represent changes in the underlying data. The display subsystem 78 may include one or more display devices and may be combined with logic subsystem 61 and/or the storage subsystem 63, such as in a common housing, or such display devices may be separate or external peripheral display devices.

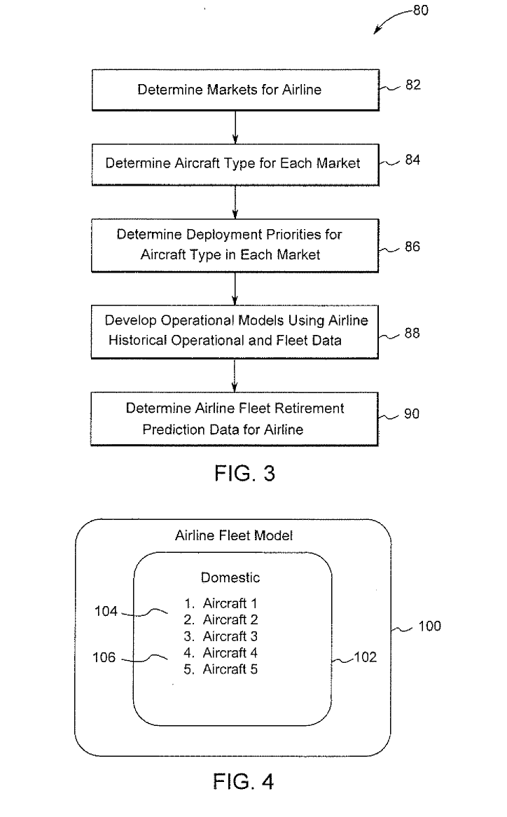

Thus, the various components, sub-systems, or modules of the system 60 may be implemented in hardware, software, or a combination thereof, as described in more detail herein. Additionally, the processes, methods, and/or algorithms described herein may be performed using one or more processors, processing machines or processing circuitry to implement one or more methods described herein (such as illustrated in FIG. 3).

In various embodiments, different input data and criteria may be used by the logic subsystem 61 within an airline fleet retirement modeling framework 62 (e.g., the logic subsystem 61 controls the airline fleet retirement modeling framework 62) to generate one or more outputs predictive of or forecasting airline fleet retirement, such as for one or more aircraft or aircraft type 56 for the airline. It should be noted that the inputs received by the airline fleet retirement modeling framework 62 (which may be one or more modules or processing circuitry) include data corresponding to the specific airline of interest and the airline fleet model 50 likewise is specific to the airline of interest as described in more detail herein.

The airline fleet retirement modeling framework 62 generally receives airline specific data, which may include publically available data or data generated based on analysis, such as, data from a subject matter expert (SME). In the illustrated embodiment, the airline fleet retirement modeling framework 62 receives as inputs (or accesses stored information, such as in the storage subsystem 63), Airline Historical Operational Data 64, Airline Historical Fleet Data 66, and Exogenous Factors 68. It should be noted that in some embodiments, airline operational and fleet data may not be historical data, such as delivery schedules or growth models for the airline. As discussed in more detail herein, some or all of the input data is used to generate an operational model of utilization (UTIL) 70. In various embodiments, the airline fleet retirement modeling framework 62 is configured to generate the UTIL 70 (also referred to as the UTIL model) for each aircraft type 56 (shown in FIG. 1), which may include determining for each aircraft type, an amount of flight time over a year. Additionally, the airline fleet retirement modeling framework 62 is various embodiment also is configured to generate (i) an operational model of aircraft flying hours (AFH), also referred to as the AFH model 72, and (ii) an operational model of aircraft count (AC), also referred to as the AC model 72. Thus, using a combination of one or more of the airline fleet model 50, the UTIL model 70, the AFH model 72, and the AC model 74, the airline fleet retirement modeling framework 62 is configured to generate the output 76, which is an airline fleet retirement prediction output specific to the airline. Additionally, the output 76 may include separate predictions for each of UTIL, AFH, and AC. The output 76 may be communicated to a display 78 for viewing by a user. It should be noted that the UTIL model 70, the AFH model 72, and the AC model 74 may collectively form a single operational model.

With respect particularly to the inputs, the Airline Historical Operational Data 64 includes in some embodiments, proprietary data or results data from analysis, which may provide information related to the predicted market size and/or market groups determined as described in more detail herein. The Airline Historical Operational Data 64 can also include data related to UTIL, AFH, and AC. For example, in some embodiments, the Airline Historical Operational Data 64 includes or may be used to determine the number of hours flown by each aircraft in the airline fleet (e.g., 3000-4000 hours of flight time in a year). The data for the Airline Historical Operational Data 64 may be yearly totals or averaged totals over a number of years.

The Airline Historical Fleet Data 66 includes, for example, inventory data regarding the airline fleet. For example, in the illustrated embodiment, the Airline Historical Fleet Data 66 includes aircraft count (AC) data, aircraft type (A/C) data, aircraft age data, and aircraft capacity data. It should be noted that the Airline Historical Fleet Data 66 may be acquired from one or more public data sources, such as, government filings, advertising material, etc. The Airline Historical Fleet Data 66 similarly may be annual data (or monthly or quarterly data) for one or more years for the airline. The Airline Historical Fleet Data 66, thus, generally provides data for the airline relating to aircraft inventory, such as the number of aircraft of each type and the age of the different aircrafts, the configuration of the aircrafts, such as the capacity (passenger and/or cargo) for the aircrafts, among other information.

Additionally, the Exogenous Factors 68 may be used as inputs (and which may be stored in the storage subsystem 63) to the airline fleet retirement modeling framework 62. For example, AFH or market size growth data based on global economic forecasts, A/C delivery schedule data, options data, etc. may be part of the Exogenous Factors 68. Some of the data, for example, such as the delivery schedules may be determined from SMEs who determine delivery based on known public data (such as public announcements) or past dealings or relationships with the airline, among other information. Additionally, future information, such as options for additional aircraft that may or may not be purchased may be predicted using forecast economic data (e.g., forecast country or world economy data, such as available from Moody's). The Exogenous Factors 68 also may include user inputs to allow “what-if” scenarios (e.g., different forecasts for market growth, different assumptions for deliveries of new aircraft, etc.). These factors may be, for example, user-inputted scenarios, or may be based on other models (e.g., a model of market growth based on GDP forecasts). For example, a scenario based approach may be used based on different degrees of certainty of the information or different cases (e.g., best case, middle case, and worst case).

Additionally, for different input or parameters, assumptions may be used to generate one or more different models. For example, a growth rate model may be assumed, such as, 1%, 2% or other values, over a certain time period. As an example, in some embodiments, a growth rate model may be assumed as part of the AFH model 72.

In general, the input data for the airline fleet retirement modeling framework 62 is used to generate or develop the operational models (UTIL model 70, AFH model 72, and AC model 74). It should be noted that these operational models may be developed, for example, using methods know in the art. In some embodiments, one or more of the operational models is developed or generated using:

1. Regressions based on historical data;

2. Simultaneous or concurrent regressions based on historical data;

3. Simulation methods;

4. Simulation-optimization methods; and/or

5. Other methods to predict future activity.

Accordingly, various embodiments of the system 60 are configured to provide airline fleet retirement prediction using historical-based data and/or simulation-based utilization models. Different methods and algorithms for generating and/or using the data will be described in more detail herein.

In some embodiments, the UTIL, AC, and/or AFH are forecast on a periodic basis such that these three parameters are consistent. For example, in one embodiment, the UTIL, AC, and/or AFH are determined, such that each satisfies the following relational equation: UTIL=(AFH/AC)*(365 days/time period). Thus, for example, for quarterly analysis, the factor 365/time period is 4 and for monthly analysis, the factor is 12.

Additionally, the output data may be generated and provided in different formats. For example, the output 76 may be a graph of AC versus time (e.g., over a 15-30 year time period) that is displayed or presented for viewing by the display subsystem 78. As other examples, graphs can also be generated to show utilization, AFH, and other parameters as desired (e.g., with an emissions model layer, the airline can predict fleet-wide emissions profile, or fuel-use, etc.).

Thus, in various embodiments, a structured problem is defined based on one or more markets and one or more priorities for each aircraft type. For example, if an airline uses a number of different aircraft types (e.g., 20 different types of aircrafts), the aircrafts may be grouped based on flight leg times or region information (e.g., inter-continental versus intra-continental) to define the markets for the airline fleet model 50 (shown in FIG. 1). For example, for a particular airline, a data driven method in a market divided fleet of aircraft is used to determine priorities of use for aircraft types 56 in each of the markets. The priority order 54 (shown in FIG. 1) in some embodiments generally defines a preference of deployment for the aircraft types 56 in each of the markets 52. As should be appreciated, each airline may have different aircraft types 56 in each of the markets 52 with different priorities of deployment for the aircraft types 56 as well. Additionally, in cases where some of the aircraft types 56 for different airlines are within the same markets 52, the priority of deployment may still be different as described in more detail herein. For example, based on the configuration of the aircraft and other factors, the lowest operating cost for that airline is given a highest priority (priority 1), with higher cost aircraft having a lower priority (e.g., priority 2 or 3), which can occur, such as when the aircraft for that aircraft type 56 are phased out that may be due to age (and a newer fleet is purchased), thereby making the older aircraft more costly to operate relative to the newer fleet. As should be appreciated, the analysis may be based on an ongoing model, such that if the older aircraft type 56 is replaced by new or newer aircraft type 56, the aircraft type 56 may maintain at the same priority level.

In various embodiments, the structured problem may be based on airline specific data corresponding to a business model for the airline. For example, the business model may result in aircraft types 56 being separated or divided into the markets 52 based on particular routes served or to be served by the aircraft for that airline. The business model may include a cost structure for that airline, such as using different factors that affect how one airline deploys a particular aircraft. For example, one or more airlines may deploy an aircraft type differently than one or more other airlines based on a cost structure for that aircraft type. Thus, instead of holistically using or accessing data relating to the entire global aircraft fleet, various embodiments use airline specific data to define the airline fleet model 50. For example, for entities concerned with individual airlines, various embodiments provide the output 76 that allows for airline specific or airline centric prediction that can be used to assess fleet planning, maintenance planning, and/or spare parts forecasting, among others.

Various embodiments provide a method 80 as shown in FIG. 3 for airline fleet retirement prediction. The method 80, for example, may employ structures or aspects of various embodiments (e.g., systems and/or methods) discussed herein. In various embodiments, certain steps may be omitted or added, certain steps may be combined, certain steps may be performed simultaneously, certain steps may be performed concurrently, certain steps may be split into multiple steps, certain steps may be performed in a different order, or certain steps or series of steps may be re-performed in an iterative fashion. In various embodiments, portions, aspects, and/or variations of the method 80 may be able to be used as one or more algorithms to direct hardware to perform operations described herein.

The method 80 includes determining aircraft markets for an airline at 82. For example, as described herein, for a particular airline, each aircraft type may be used in different markets (e.g., markets 52 as shown in FIG. 1), which are defined generally by the type of flight travel (e.g., length or flight legs or distance traveled). However, in some embodiments, the markets may be user defined based on other criteria, such as based on an analysis of the airline's fleet and how the airline deploys aircraft within this fleet. For example, an SME may provide the user input. It should be noted that in various embodiments, while the markets may initially be defined based on flight leg, other or different criteria may be used for defining the markets.

The aircraft markets for several airlines may be the same or may be differently defined, such as, based on the routes traveled by that airline. The markets are used as part of an airline fleet model (e.g., the airline fleet model 50 show in FIG. 1), which may be part of an airline fleet retirement modeling framework (e.g., the airline fleet retirement modeling framework 60 shown in FIG. 2) as described herein.

The method 80 also includes determining the aircraft type or grouping the aircraft type for or within each market at 82. For example, as described herein, for the markets defined for a particular airline, each of a plurality of aircraft types (e.g., aircraft types 56 shown in FIG. 1) are categorized within one of the markets. In various embodiments, similar aircrafts may be categorized in different markets, such as based on the routes flown by the aircraft. Thus, although some aircrafts may have similar characteristics (e.g., seating or cargo capacity), the aircraft types may be categorized in different markets as a result of the aircraft type being used for different routes (e.g., different lengths of routes). In some embodiments, if the same aircraft type has several aircrafts in the airline's fleet, and at least some fall within different markets, the aircraft types may be split between the markets, or for example, categorized in the market having more of that particular aircraft type.

It should be noted that in some embodiments, an aircraft type may be split or divided into subfleets. For example, assume an airline has 100 747s. If it is known or determined, such as from an analyst, that 50 of the 747s are expected to retire first (for any reason), the aircraft type may be split or divided into 747 Group1 and 747 Group2 and the 747s assigned different priorities within the same market. Alternatively, the 747s may be assigned to different markets. For example, when determining the various inputs, for example, to define an input file (e.g., prepared by an analyst), different types of information may be used in order to determine the aircraft priorities.

It should also be noted that each aircraft priority group in various embodiments typically consists of multiple (e.g., five or six) of “subtypes” of that aircraft type. For example, 747 Group1 might consist of multiple subtypes of 747s or may include just the 747s that were entered into service between a particular time-period (since aircraft deliveries span sometimes ten years, the airline might want to split out the first five years of aircraft from the last five years into separate groups). Additionally, the “grouping” may be performed or defined based the most detailed level for the aircraft, such as an aircraft tail number level of detail.

Thus, at 84, in various embodiments, the aircraft are grouped by type within one of a plurality of markets. For example, a determination is made as described herein as to which of a plurality of aircraft type for the airline are to be placed within each of the markets. As also described herein, market size metrics also may be defined, such as based on aircraft flying hours (or other metrics).

The method 80 additionally includes determining one or more deployment priorities for each aircraft type in each of the markets at 86. For example, an order of priority (e.g., priority order 54 shown in FIG. 1) for deployment or usage of each aircraft type within each of the defined markets is determined. In some embodiments, different factors such as age and/or cost of operations affect the deployment within each market. However, it should be noted that for two different airlines having some of the same aircraft in a defined market, the order of priority may be different. This difference in priority of deployment may be based on how the airline is able to use the aircraft or other factors. For example, one airline may have newer aircraft of a particular aircraft type than another airline. In some embodiments, information from an SME is used and provides value by analyzing the airline operations.

It should be noted that market interactions also may be determined, for example, a determination of different redeployments of aircraft type as described herein. For example, as part of the determination of deployment priorities or separately therefrom (illustrated at 88), a determination is made as to aircraft that may be redeployed, such as aircraft that may be moved between markets or from one market to one or more different markets.

The method 80 also includes developing operational models using airline operational data and airline fleet data at 90. For example, as described herein, different operational models (e.g., UTIL model 70, AFH model 72, and AC model 74 as shown in FIG. 2) may be developed or generated using different methods. The operational models are airline specific or airline centric. The operational models in some embodiments are based at least in part on historical data for the particular airline. However, in other embodiments, the operational models may additionally or optionally be developed using simulation data as described herein. The data used to generate the operational models may be different types of data available from public sources, determined through separate analysis, and/or determined from SMEs, among others. The operational models may provide a statistical framework from which predictive or forecast data may be generated. In some embodiments, the one or more operational models may be linked together using one or more characteristics or parameters as described herein. In various embodiments, an operational model is generated for each aircraft type based on airline specific data.

The method 80 further includes predicting airline fleet retirement for the airline at 92. For example, UTIL, AFH, and/or AC prediction data may be generated as described in more detail herein. The prediction results may be an output that is provided in different formats, for example, as a graph, chart, etc. In one embodiment, the retirement prediction data may be determined using the following information as described in more detail herein:

1. Market definition;

2. Deployment priorities;

3. Delivery schedules for each aircraft type;

4. Growth forecast; and/or

5. Historical fleet and operational data (if available)

In some embodiments, prediction of airline fleet retirement includes using all information (1-5 above). For example, using the information set forth above (or other or different information as described herein) an entire airline may be modeled to obtain or determine a forecast for retirement (e.g., a forecast retirement schedule) for each aircraft for the airline. In some embodiments, the modeling includes using a fleet composition or fleet mix analysis as described herein, which may include utilizing growth model information (e.g., information regarding markets in which aircraft are to expand or planned to expand) or delivery schedule information. In some embodiments, this information, including the growth model information and delivery schedule information may be based on prediction from one or more SMEs, results from other models, other analysis, and/or published data, among other information. Thus, in various embodiments, a mix of different data or different types of data may be used (e.g., mix of heterogeneous types of data). Accordingly, in some embodiments, a mix of different fidelity of data may be used. For example, some of the data may be more reliable or have a higher predictive value than other data. In various embodiments, the data optionally may be weighted based on a determination of the fidelity of the data.

In operation, fleet retirement predictions or forecasts are determined in an airline specific or airline centric manner as described herein, such as using one or more developed operation models. For example, in some embodiments, the markets for the airline are defined, such that the entire fleet for the airline may be grouped into different ones of the markets. Within each market, deployment priorities are determined as described herein for the aircraft types grouped within each market (which may also include determine redeployment possibilities or opportunities).

With the markets and deployment priorities determined, a market size for each of the markets may be determined using, for example, the flight hours for the aircraft type×capacity of the aircraft (passenger or cargo)×the number of aircraft. Thus, an overall size of the market per aircraft type may be determined. In various embodiments, one or more utilization models are then developed and may be used to determine the utilization of each aircraft type within each of the markets, such as whether all aircraft type within a market will be fully utilized. For example, a year by year forecast may be determined based on one or more utilization models. In some embodiments, the forecast of the utilization of the aircraft type in each market includes determining the overall flight hours for the aircraft type within the market and then allocating the hours based on the deployment priorities. Thus, within each market, the higher deployment aircraft types are allocated the flight hours first.

For example, the highest deployment priority aircraft are allocated all the hours to fill the available flight legs for that aircraft type, followed by the next highest deployment priority aircraft type, until all of the hours are deployed. If the all aircraft type within the market are filled or allocated the maximum available flight hours and additional hours remain to be allocated, additional aircraft will be need or hours filled within another market. However, if the total forecast hours are filled or allocated and aircraft type are not utilized or not fully utilized, the aircraft type may be redeployed (if redeployment is a possibility) to another market or retired. For example, if a particular aircraft type has zero hours allocated to that aircraft type, then the aircraft type is retired within that market or moved to another market.

It should be noted that various types of information may be used in the forecasting, which may include known or predictive information. For example, known retirement schedules or known lease returns or aircraft parkings may be used as part of the growth forecast for each market, which may be a positive or negative value based on whether the forecast is for increased or decreased use.

It also should be noted that the methods and algorithms described herein may be applied or used for each of a plurality of time steps. For example, as described in more detail herein, the time steps may be yearly quarters, months, or other time periods. The methods or algorithms may also be applied to different market size metrics (MSMs) as described in more detail herein. Additionally, different iterations of the methods or algorithms may be based in part on whether the aircraft type is still being delivered (e.g., still being sold to the airline). For example, a different utilization model may be used based on whether the aircraft type is still being delivered. Thus, in some embodiments, the UTIL function is defined differently based on whether the aircraft types are still being delivered or forecast to be delivered.

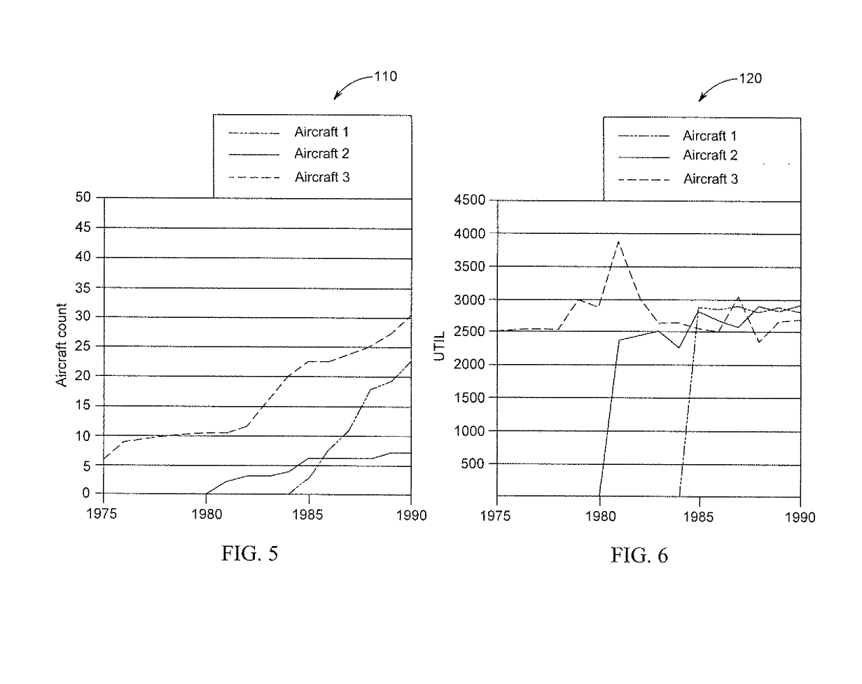

FIG. 4 illustrates a portion of an exemplary airline fleet model 100 for which analysis was performed in accordance with various embodiments (the data being simulated data and not actual data). Although only a single market 102 is defined, multiple markets, for example, the markets 52 (shown in FIG. 1) may be defined. In this embodiment, the market 102 is defined as domestic flight legs, such as corresponding to flights within the continental U.S., which may be, for example, flights of less than 6 hours. In this embodiment, five different aircraft type 104 are defined and prioritized based on deployment priorities for the airline (with 1 being the highest priority and 5 being the lowest priority). It should be noted that while the aircraft type are from the same aircraft manufacture (Boeing, formerly McDonnell Douglas), the aircraft type 104 may include aircraft manufactured by different companies.

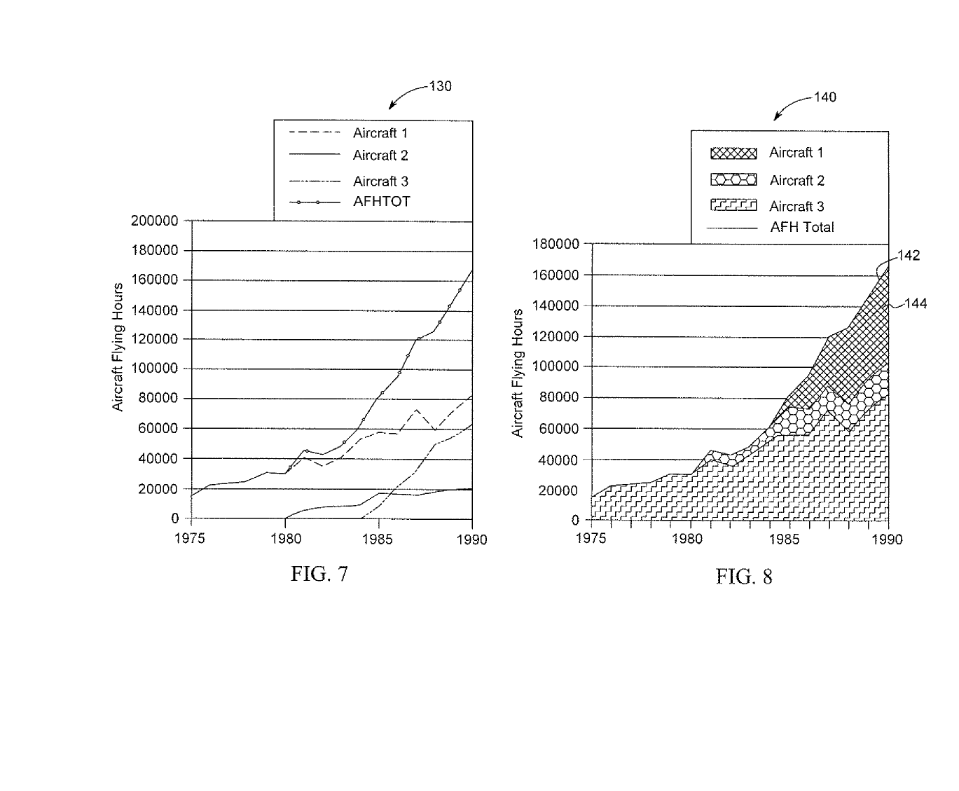

In particular, FIGS. 5-8 illustrates graphs 110, 120, 130, 140, respectively, of sample input data, for example historical data (such as Airline Historical Operational Data 64, Airline Historical Fleet Data 66 as shown in FIG. 2), which has been determined for a fifteen year period (illustrated as 1975-1990). The horizontal axis on each graph 110, 120, 130, 140 corresponds to time and the vertical axis corresponds to aircraft count, UTIL, AFH, and cumulative AFH (shown by the curve 142), respectively. The graphs 110, 120, 130, 140 show the increase in both the number of aircraft and corresponding use (as the aircraft count increases) for each of the aircraft type. In particular, each curve within a respective graph 110, 120, 130, 140 corresponds to historical data for each of the aircraft type 104 (shown in FIG. 4). It should be appreciated that if a gap existed between the curve 142 in the graph 140 and the corresponding region 144 below, which is not the case here, then this airline would need more aircraft.

With respect to the graph 140, the data illustrated shows how an airline will meet the forecast demand (or more how the airline will fall short). The curve 142 (illustrated as a line) shows the expected growth of the market. Then, each of the stacked regions 144 shows each specific aircraft grouping within the market. If the cumulative stack falls short of the curve 142, this is indicative that an airline will be unable to meet expected demand. As should be appreciated, various embodiments provide a “scenario tool” such that a determination can be made that with the expected deliveries, the expected demand will not be met in the future. Because aircraft deliveries are sometimes 5-10 years out from the order date, the airline may then decide, for example, to immediately order additional aircraft (or identify leasing options, including extending existing leases). Accordingly, various embodiments may be used as a fleet-planning tool. However, as discussed in more detail herein, various embodiments provide a fleet-retirement prediction tool. Additionally, other uses may be provided, such as by a lessor to target specific airlines as potential opportunities for additional leases.

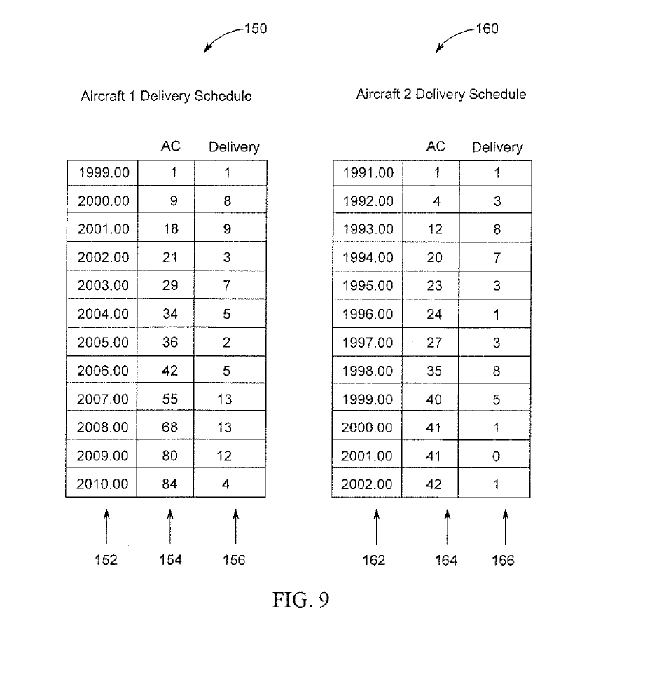

FIG. 9 illustrates tables 150, 160 for a forecast delivery scenario. Columns 152, 162 correspond to the year, columns 154, 164 correspond to the AC, and columns 156, 166 correspond to the predicted delivery. Thus, the AC columns 154, 156 show the aircraft count for two different aircraft types 104 and the columns 156, 166 show the predicted delivery for each year (based on a regression model analysis).

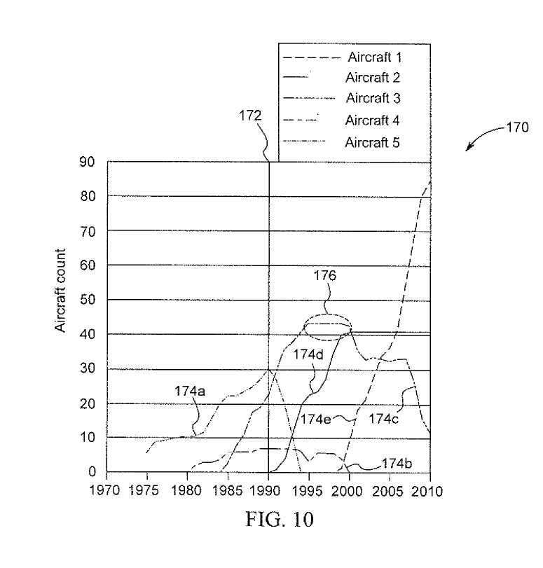

The graph 170 of FIG. 10 shows the output (such as the output 76 of FIG. 1), which is an airline fleet retirement prediction for the airline in this example, wherein the horizontal axis corresponds to time and the vertical axis corresponds to AC. The graph 170 shown a 20 year ahead forecast with the line 172 dividing historical data on the left and forecast or predictive data on the right determined using various embodiments described herein. For each of the five curves 174a-e corresponding to the five aircraft types 104 (shown in FIG. 4), the increasing portion of the curves 174a-e corresponds to an increase in the use of the aircraft type, a generally flat portion of the curves 174a-e (e.g., portion 176 of curve 174e) corresponds to maintaining the aircraft type, and a decreasing portion of the curves 174a-e corresponds to retiring the aircraft type. When AC=0, the aircraft type is considered retired. As can be seen by the curves 174a-e, using various embodiments, a determination of the retirement profile for each of a plurality of aircraft for the airline may be determined.

Thus, various embodiments provide systems and methods to predict or forecast aircraft retirement within an airline fleet. In particular, a systematic approach to modeling the entire airline considering individual aircraft utilization may be provided.

It should be noted that the particular arrangement of components (e.g., the number, types, placement, or the like) of the illustrated embodiments may be modified in various alternate embodiments. In various embodiments, different numbers of a given module or unit may be employed, a different type or types of a given module or unit may be employed, a number of modules or units (or aspects thereof) may be combined, a given module or unit may be divided into plural modules (or sub-modules) or units (or sub-units), a given module or unit may be added, or a given module or unit may be omitted.

It should be noted that the various embodiments may be implemented in hardware, software or a combination thereof. The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a solid state drive, optical drive, and the like. The storage device may also be other similar means for loading computer programs or other instructions into the computer or processor.

As used herein, the term “computer,” “controller,” and “module” may each include any processor-based or microprocessor-based system including systems using microcontrollers, reduced instruction set computers (RISC), application specific integrated circuits (ASICs), logic circuits, GPUs, FPGAs, and any other circuit or processor capable of executing the functions described herein. The above examples are exemplary only, and are thus not intended to limit in any way the definition and/or meaning of the term “module” or “computer.”

The computer, module, or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer, module, or processor as a processing machine to perform specific operations such as the methods and processes of the various embodiments described and/or illustrated herein. The set of instructions may be in the form of a software program. The software may be in various forms such as system software or application software and which may be embodied as a tangible and non-transitory computer readable medium. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program. The individual components of the various embodiments may be virtualized and hosted by a cloud type computational environment, for example to allow for dynamic allocation of computational power, without requiring the user concerning the location, configuration, and/or specific hardware of the computer system.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments, and also to enable a person having ordinary skill in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or the examples include equivalent structural elements with insubstantial differences from the literal languages of the claims.

What is claimed is:

1. A non-transitory computer readable storage medium for predicting aircraft retirement within a fleet of an airline using a processor, the non-transitory computer readable storage medium including instructions to command the processor to:
obtain market information for the airline that defines at least one market for the airline;
determine a plurality of aircraft types for the airline within the at least one market to define an airline fleet model;
determine deployment priorities for the plurality of aircraft types within the at least market;
develop one or more operational models using at least one of airline operational data or airline fleet data for the plurality of aircraft types; and
determine aircraft retirement prediction data for the airline using the airline fleet model and the one or more operational models developed for the airline.

2. The non-transitory computer readable storage medium of claim 1, wherein the instructions command the processor to develop the operational models by generating one or more of an operational model of utilization (UTIL), an operational model of aircraft flying hours (AFH), or an operational model of aircraft count (AC) including using delivery schedule information for each of the plurality of aircraft type.

3. The non-transitory computer readable storage medium of claim 1, wherein the instructions command the processor to use one of historical data or simulation data for the airline operational data or airline fleet data.

4. The non-transitory computer readable storage medium of claim 1, wherein the instructions command the processor to develop the one or more operational models by using one or more exogenous factors.

5. The non-transitory computer readable storage medium of claim 1, wherein the instructions command the processor to determine the deployment priorities by identifying preferred usage priorities for the aircraft type.

6. The non-transitory computer readable storage medium of claim 5, wherein the instructions command the processor to define the at least one market and determine the plurality of aircraft types for the at least one market by using flight leg information, and determine the deployment priorities by using aircraft age information.

7. The non-transitory computer readable storage medium of claim 1, wherein the instructions command the processor to define the airline fleet model by using a market size metric for the airline.

8. The non-transitory computer readable storage medium of claim 1, wherein the instructions command the processor to determine the aircraft retirement prediction data by using only data for the airline and without global aircraft data for a plurality of airlines.

9. The non-transitory computer readable storage medium of claim 1, wherein the instructions command the processor to develop the one or more operational models by using one or more regression or simulation methods.

10. The non-transitory computer readable storage medium of claim 1, wherein the instructions command the processor to predict a size for the least one market by using a carrying capacity metric for an aircraft within the airline.

11. The non-transitory computer readable storage medium of claim 1, wherein the airline is one of a commercial airline or a cargo airline.

12. The non-transitory computer readable storage medium of claim 1, wherein the instructions command the processor to obtain the market information, determine the plurality of aircraft type, and determine the deployment priorities one of regionally or globally, and wherein the instructions further command the processor to develop the one or more operational models and determine the aircraft retirement data one of regionally or globally.

13. The non-transitory computer readable storage medium of claim 1, wherein the instructions command the processor when determining the plurality of aircraft types and determining the deployment priorities to group the aircraft using at least one of a type of the aircraft or a sub-type of the aircraft.

14. A computer-implemented system for predicting retirement of aircraft from an airline fleet, the computer-implemented system comprising:
a storage subsystem; and
a logic subsystem operatively coupled to the storage subsystem, the logic subsystem controls the execution of an airline fleet retirement modeling framework to obtain from the storage subsystem market information for the airline that defines at least one market for the airline, the logic subsystem further controls the airline fleet retirement modeling framework to determine a plurality of aircraft priority groupings for the airline within the at least one market to define an airline fleet model, and determine deployment priorities for the plurality of aircraft priority groupings within the at least market, the logic subsystem additionally controls the airline fleet retirement modeling framework to develop one or more operational models using at least one of airline operational data or airline fleet data for the plurality of aircraft priority groupings to determine aircraft retirement prediction data for the airline using the airline fleet model and the one or more operational models developed for the airline.

15. The computer-implemented system of claim 14, wherein the logic subsystem further controls the airline fleet retirement modeling framework to develop as the operational models, one or more of an operational model of utilization (UTIL), an operational model of aircraft flying hours (AFH), or an operational model of aircraft count (AC) including using delivery schedule information for each of the plurality of aircraft type.

16. The computer-implemented system of claim 14, wherein the logic subsystem further controls the airline fleet retirement modeling framework to use one of airline historical operational data or airline historical fleet data as the airline historical data.

17. The computer-implemented system of claim 14, wherein the logic subsystem further controls the airline fleet retirement modeling framework to develop the operational models using one or more exogenous factors stored in the storage subsystem.

18. The computer-implemented system of claim 14, wherein the logic subsystem further controls the airline fleet retirement modeling framework to define as the deployment priorities, preferred usage priorities for the aircraft type.

19. The computer-implemented system of claim 18, wherein the logic subsystem further controls the airline fleet retirement modeling framework to determine the plurality of aircraft priority groupings for the at least one market using flight leg information, and determine the deployment priorities using aircraft age information.

20. The computer-implemented system of claim 14, wherein the logic subsystem further controls the airline fleet retirement modeling framework to define the airline fleet model using a market size metric for the airline.

21. The computer-implemented system of claim 14, wherein the logic subsystem further controls the airline fleet retirement modeling framework to determine the aircraft retirement prediction data using only data for the airline and without global aircraft data for a plurality of airlines.

22. The computer-implemented system of claim 14, wherein the logic subsystem further controls the airline fleet retirement modeling framework to determine the aircraft retirement prediction data one of regionally or globally.

23. The computer-implemented system of claim 14, further comprising a display subsystem configured to display a graph showing the aircraft retirement prediction data for the airline, wherein a plurality of curves are displayed on the graph, each of the curves corresponding to a different one of the aircraft types.

24. The computer-implemented system of claim 14, wherein the logic subsystem further controls the airline fleet retirement modeling framework to determine operational parameters including at least one of aircraft utilization, emissions or fuel usage.

25. The computer-implemented system of claim 14, further comprising a display subsystem configured to display a graph showing one or more of the operational parameters.

26. The computer-implemented system of claim 14, further comprising a display subsystem configured to display a graph showing cumulative market size metric data as part of the aircraft retirement prediction data for the airline.
